(19) United States
(12) Patent Application Publication
(10) Pub. No.: US 2015/0124622 A1
(43) Pub. Date: May 7, 2015

(54) Multi-Interface, Multi-Layer State-full Load Balancer For RAN-Analytics Deployments In Multi-Chassis, Cloud And Virtual Server Environments

(71) Applicant: Movik Networks, Inc., Westford, MA (US)

(72) Inventors: Surya Kumar Kovvali, Westborough, MA (US); John Hutchins, Groton, MA (US); Nizar Puriyal, Bangalore (IN); Charles W. Boyle, Upton, MA (US)

(21) Appl. No.: 14/530,072

(22) Filed: Oct. 31, 2014

Related U.S. Application Data
(60) Provisional application No. 61/898,832, filed on Nov. 1, 2013.

(51) Int. Cl. H04W 28/02; H04W 24/08; H04L 12/803; H04W 28/08

(52) U.S. Cl. CPC H04W 28/0215; H04W 28/08; H04W 24/08; H04L 47/125
USPC 370/236

(57) ABSTRACT

An apparatus and method for steering and load-balancing mobile network traffic with user session awareness from multiple control and user plane protocols while understanding the load on the corresponding physical or virtual servers in cloud and virtual deployments is disclosed. This traffic could be monitored traffic, such as from optical taps, or network probes of mobile network interfaces, or port mirrors from network devices, or inline traffic when the load-balancer is logically placed inline in the network before the Virtual Network Functions, such as Virtual SGW (vSGW), Virtual SGSN (vSGSN), Virtual PGW (vPGW), Virtual MME (vMME), or Virtual Performance Enhancing proxy(vPEP). The apparatus and methods identified herein allow additional capabilities, such as ensuring that both directions of a protocol flow target the same physical or virtual server, or both control plane and user plane protocols of a flow are forwarded to the same server.

This application claims priority of U.S. Provisional Patent Application Ser. No. 61/898,832, filed Nov. 1, 2013, the disclosure of which is incorporated herein by reference in its entirety.

### BACKGROUND

Wireless networks use dense network functions with a hierarchy of RAN and Core Network protocols in accordance with the 3GPP (GSM/UMTS/LTE) or CDMA standards to establish subscriber sessions, handle mobility, and transport data from/to User Equipment (UE) to operator Gi networks that host Optimization and Performance Enhancing Proxies, Firewalls and other devices that connect to the Internet.

For example, in UMTS, Base Stations at the edge of the network are connected to a Radio Network Controller (RNC) through a transit ATM/IP backhaul network, and several of these RNCs are aggregated through a SGSN at regional data center location, and several SGSNs are connected to a GGSN that terminates user plane tunnels, and carries data through NAT, Operator Firewalls and other devices before routing to Internet. The interface protocol traffic, such as IUCS-CP, IUCS-UP, IUPS-CP, IUPS-UP, S1AP, S1U, S11 and others, that is backhauled to aggregate locations, is high volume. For example, the traffic at an SGSN location may correspond to 1+ million subscribers. It may not be possible to perform the dense network functions, such as SGSN and SGW, using single processing entities such as a Server Blade, or a single CPU. Thus, traffic needs to be distributed from dense aggregate interfaces (IUPS, S1U, S1AP etc., protocols over 1/10/40 Gbps) to multiple processing entities. Moreover, due to mobility reasons, and due to different services provided by different Access Point Networks (APNs), one subscriber's traffic may be carried with different transport addresses (RNC-IP, SGSN-IP, RNC-TEID, SGSN-TEID etc.) at different times or at the same time (multiple APNs). For example if a subscriber has two tunnels, such as one tunnel for QCI9 (Internet-APN), and a second tunnel for on-deck APN, the two transport addresses would be different. Thus, prior-art L3/L4 load-balancing methods based on transport headers may not identify user IP flows to steer flows of same user to same Server/Processing entity.

Recent evolution of Network Function Virtualization (NFV) and Software Defined Networking (SDN) methods migrate dense network functions, such as MME, SGSN, SGW, and PGW, to Virtual Servers in operator cloud data centers. This requires aggregating logical interfaces such as IUPS, S1AP, S1U etc., from different geographical locations to dense interfaces (10/40 Gbps) and transporting the data to operator datacenter. However, since single blade/CPU, memory, and storage systems can't handle such dense feeds, it requires distributing the network traffic among multiple virtual servers. Current methods based on L3/L4 protocol headers are inadequate to steer flows that have relationships beyond the L3/L4 headers, such as within IP tunnels or if the relationship is identifiable in a different logical protocol (for example IUPS, S1AP etc., Control protocols); thus flow steering based on richer set of constraints from multiple interfaces to processing entities is required.

Co-pending U.S. Patent Publication 2013/0021933 discloses estimating Network and User KPIs by correlating multiple RAN protocol interfaces. Operator migration to NFV requires the Real-Time Analytics and KPI functions (RAF) to be deployed on virtual servers in operator cloud data centers. If the network functions such as MME, SGSN, and SGW are virtualized and migrate to the datacenter locations, the logical interfaces that feed to such Virtual Network Functions (VNFs) will be backhauled to these data center locations as dense feeds. Correlating and computing metrics in accordance with U.S. Publication 2013/0021933 requires splitting the dense feed to multiple virtual servers for flexible scaling. Since these metrics are computed from interface protocols, distributing related subsets to the same server minimizes dense communication between the virtual servers when computing the KPIs.

Additionally, some network functions, such as SGSN and SGW, may not have migrated to operator datacenters and the required logical interfaces such as IUCS-CP, IUPS-CP, and IUPS-UP may not be available in the datacenter locations. This requires receiving such interface traffic from edges of the network using optical taps or port mirrors from Network elements, aggregating them and transporting to the location where RAF servers are deployed. Efficiently transporting monitored traffic from optical taps and port mirrors, removing off un-needed headers and truncating packets while transporting through transit L2/L3 operator networks requires specific rules. These rules include stripping of L2 headers, protocol aware variable length truncation of packets, dropping intermediate packets of a HTTP transaction and adding GRE or IP in IP header to over-ride L2/L3 network forwarding rules. Prior-art methods, such as local and remote SPANs (Switched Port Analyzer), tunneling bridged or mirrored packets within GRE headers do not facilitate stripping off un-needed headers, variable length truncation of packets, and forwarding based on correlated information from multiple logical interfaces. For example, when both directions of flow of an interface are received from optical taps, combining both directions of flows on an Ethernet interface causes MAC learning problems in L2 switches since a MAC address may appear as both source and destination on the same port. Such packets need to be encapsulated with additional L2/L3 forwarding headers.

Distributing traffic from network interfaces based on well-defined protocol headers, namely Layer2 MAC headers, Layer 3 IP addresses, and Layer 4/UDP/TCP port-numbers to a plurality of application servers such as Web Server, Video Server, Database Server etc. is well known, and Load-balancers perform such functions. For example, at a website that handles high volume web traffic on HTTP port 80 of a multi-gigabit interface where a single web-server cannot handle the volume, the traffic is distributed to multiple servers based on L2/L3/L4 headers, as shown in FIG. 1. Such load-balancing function is performed by a network interface blade in a chassis (for example L2/L3 switch in a ATCA or Blade Server chassis) or by a Layer 2/Layer3 switch that supports 5-tuple based forwarding.

Software Defined Networking (SDN) includes methods in which a SDN network controller communicates with one or more network switches/routers within a data center to distribute network traffic received in a data-center to plurality of virtual servers where the virtual servers run on virtual or physical machines or on a blade server in a chassis. Since the processing, storage and network interface capacity that such a virtual server can handle is very dynamic and depends on physical hardware, types of applications and volume of traffic, the controller monitors the load level of the virtual server (where the load level includes: CPU, network, IO, and storage loads) and alters the forwarding decisions and reconfigures the network switches to redistribute the load to the virtual servers. The methods to reconfigure the switches/routers in the datacenter could be well known L2/L3/L4/L5-Tuple rules or use OpenFlow rules per the NFV/SDN standards. While directing a subset of flows from a dense aggregate feed, for example 40 Gbps/10 Gbps/1 Gbps to a virtual server, the prior art methods use a limited set of protocol header fields within a logical protocol, and do not use the information from other related protocols. For example, current methods do not use S1AP Control plane protocol while directing S1U flows to ensure multiple S1U sessions from multiple APNs, or multiple QCIs are directed to the same virtual server, or S1U sessions of multiple users within the same sector or eNB, or group of eNBs in the same area are serviced by the same virtual server.

Therefore, a system and method that extends the current techniques to include additional information in order to make more optimized decisions regarding load balancing would be beneficial.

### SUMMARY

The present disclosure is directed toward steering and load-balancing mobile network traffic with user session awareness from multiple control and user plane protocols while understanding the load on the corresponding physical or virtual servers in cloud and virtual deployments. Such traffic could be monitored traffic, such as from optical taps, or network probes of mobile network interfaces, or port mirrors from network devices, or inline traffic when the load-balancer is logically placed inline in the network before Virtual Network Functions, such as Virtual SGW (vSGW), Virtual SGSN (vSGSN), Virtual PGW (vPGW), Virtual MME (vMME), or Virtual Performance Enhancing proxy (vPEP). The methods identified herein add additional constraints such as, both directions of a protocol flow targeted to the same physical or virtual server, or traffic from both Active and Standby links, or traffic from redundant routers protecting the same logical interface, or both CP and UP protocols of a flow should be forwarded to the same server, or a group of user's flows belonging to a sector, or group of sectors or a venue, or flows corresponding to a set of domains/websites or application services, are directed to the same virtual servers that perform dense analytics function, or other VNFs. Additionally, methods of terminating network tunnels (such as S1U/GTP-U tunnels) and offloading user traffic based on multi-protocol correlated information from transit network elements or operator VNFs to content provider clouds are disclosed.

The present disclosure extends the existing methods by identifying relationships across logical protocol interfaces to forward a set of related control and/or user plane protocols or user flows to the same set of virtual server (processing/storage/IO instances), so that such virtual server could use information from multiple protocols. For example, in a wireless mobile network environment such as in UMTS/LTE/CDMA/WIMAX or Wireless-LAN environment, a user device will have a control-plane session, and a user-plane session that is carried in tunnels above the L2/L3 transport layers. Forwarding control and user plane sessions to a virtual server instance requires methods not previously identified. For example, to do so requires identifying subscriber sessions and directing to a specific virtual server all related flows corresponding to user, sector, group of sectors etc. This facilitates the VNF to optimize the functions it is performing or perform additional functions, such as congestion based scheduling, since it received all related flows, or Real-Time KPIs for such actions. Alternatively, instead of identifying per subscriber flows for directing to a smaller set of virtual servers, the methods disclosed herein facilitate identifying flows corresponding to a domain such as “yahoo.com” in a geographical region, when such flows are encapsulated in protocol tunnels, such as GTP-U in S1U/LTE or IUPS/UMTS, or a set of services/application/content-types in a region, wherein the region information of a subscriber is identified from control plane or other protocols. Another alternative criterion for such relationship aware load-balancing could be to direct all flows corresponding to a type of device, Sector, NodeB, or group of sectors in a venue, to a set of virtual servers in close proximity (for example, on the same blade, or another blade in the same chassis). One of the key embodiments of the current invention is that the load-balancer correlates multiple protocol layers to determine targeted virtual server in addition to load on the virtual server. The methods and procedures identified herein could be implemented as one or more software modules and incorporated into other transit network elements or network controllers.

Another objective is to load balance monitored traffic from logical interfaces, where the monitoring uses optical tap or interface/port mirroring in transit network switch or router. As shown in FIG. 2, when traffic from a logical interface, such as IUPS in UMTS network, is monitored, both directions of traffic from the interface being monitored need to be replicated onto 1 or 2 logical interfaces, as shown in FIGS. 2 and 3. In the resulting monitored traffic stream, both the time-ordering relationship between the 2 directions of traffic, and the fact that the combined replicated traffic is coming from the same logical interface is lost. If such monitored traffic is further aggregated to a higher bandwidth interface before delivering to a virtual server that performs analytics, congestion detection, or security functions, the higher bandwidth interface contains traffic from multiple logical interfaces. For example, it may contain traffic from 2 S1U interfaces, 2 eNBs and from each S1U interface, eNB to SGW traffic, and also SGW to eNB traffic. The present disclosure identifies methods of re-establishing relationship from such aggregate flows. When traffic from both directions of an interface received on 2 optical interfaces is combined as 1 logical interface for transporting through the transit network, the traffic could not be forwarded using the standard L2/L3 rules, since one MAC Address appears as source MAC (SA) in eNB to SGW flow, and as a destination MAC (DA) in the reverse flow. For forwarding such traffic through transit L2 network and maintaining the relationship between two directions of a flow, the current disclosure identifies adding 2 consecutive VLAN tags if the traffic is untagged, or add an upper level tag (Q in Q) for each direction. While adding VLAN tags is well known in the prior art, what is novel here is automatically assigning two consecutive VLAN tags, or GRE or IP-in-IP tunnels to differentiate between two directions of flows from an interface, and using 2 such tags for each collection interface. For example, if traffic from 2 interfaces need to be aggregated on to one interface, then four tags may be used. For example, 101 and 102 may be used for 2 directions of traffic on one interface and 103 and 104 may be used for the other interface.

A traditional load balancer adds forwarding headers for transporting the received traffic (either monitored traffic or inline traffic) through transit L2/L3 network. For forwarding through an L2 network, it may add additional MAC header (MAC in MAC) to the target virtual server. Alternatively, it adds GRE header for forwarding through transit Layer 3 network. Such forwarding methods are well known in the prior art, and are dependent on the network deployment. For example, in a SDN datacenter location, it follows the corresponding methods. However, the present disclosure identifies and uses enhanced criterion for selecting the virtual server.

The load balancer itself runs on one or more virtual servers; thus the load balancing function is a distributed software module, where the set of load balancers co-ordinate with each other in performing the function.

An additional embodiment is a method for reducing IP fragmentation when tunnel headers, such as GTP-U and GRE, are added by transit network elements. Prior art methods (RFCs 791, 1191) define interface MTU size discovery and TCP/Application level adjustment so that payload lengths are adjusted to fit in the interface MTU Size. Transit network elements such as Layer 2 bridges, routers and like devices, fragment a received packet when the size is greater than the MTU Size of the outgoing interface. There is significant amount of IP fragmentation in mobile networks, particularly in RAN. In order to perform user session aware load balancing within RAN in accordance with the present disclosure, the load balancer is required to re-assemble user plane packets at the transport-ip level. This is because when a transport-ip packet is fragmented, the second packet of the fragment contains the transport-ip address only and not the GTP-U tunnel ID required for identifying user plane tunnel. To reduce such fragmentation, and the associated performance, the current disclosure proposes a network device that supports larger MTU size (for example mini jumbo frames), upon receiving a fragmented packet, the network device configures its ingress interface for the total size of the re-assembled packet. It then sends a new ICMP message, notifying the sender of the size increase. This allows the sender to send larger packets without having to fragment the packet. However, it may not be the sending device that fragmented the packet. If not, the sending device generates or forwards the ICMP message to the previous hop. This continues until the ICMP message reaches the device that is adding tunnel header. Since adding tunnel header increases packet size and thus causes fragmentation, this modification reduces the fragmentation caused by adding additional tunnel headers.

Additionally, procedures for efficient forwarding of the packets to the RAF locations, and extensions to the forwarding primitives for flexible forwarding of interface packets are additional embodiments.

The present disclosure also identifies additional constraints based on cross-correlated information from multiple logical interfaces (S1U, S1AP, S11, S4 etc.) in directing flows in a virtual environment. Targeting related user flows minimizes inter server communication for estimating Real-Time KPIs, such as Sector Utilization Level (SUL), Applicable Users for policy driven throttling, or in constructing hierarchical virtual output queues, such as per user, per sector, per eNB, or per venue queues (see FIG. 8) for hierarchical policy enforcement in a VNF device such as vSGW, or vPGW. The disclosed methods facilitate such flow steering with additional constraints.

### BRIEF DESCRIPTION OF FIGURES

FIG. 1 shows an example deployment of a router or load balancer according to the prior art that distributes load to multiple servers at an enterprise location or at Gi location in mobile operator network.

FIG. 2 is an example of a prior art deployment of Virtualized Network Functions.

FIG. 3 is a first embodiment of an example deployment of Enhanced Load balancer (ELB) 301 where the ELB 301 is shown as a distributed software module running on virtual or physical servers 210.

FIG. 4 is logical diagram showing the ELB 409 in monitoring mode receiving packets from optical taps 402,404 through aggregation switch/routers 407, 408 in the cloud data center.

FIG. 5 is a variation of monitoring mode deployment where the ELB 504 is receiving mirrored traffic from other network elements.

FIG. 6 shows flow level operation of ELB 603 when deployed in monitoring mode.

FIG. 7 shows an exemplary ELB 703 deployment in inline mode.

FIG. 8 is an example of possible actions in a NFV server, such as vSGW, vPGW, and vSGSN, made possible due to receipt of all the related flows.

FIG. 9 illustrates the functional operation of ELB according to one embodiment.

FIG. 10 shows an additional embodiment of the ELB steering selected user plane traffic based on IMSI, or domain name, APN etc. to a neighbor content cloud data center.

FIG. 11 shows control and user plane flow group indices and lookup keys.

FIG. 12 shows the logical system architecture according to one embodiment.

FIG. 13 is an example of a prior art deployment detailing transit network.

FIG. 14 depicts one embodiment in monitoring mode of a transit network.

FIG. 15 illustrates one embodiment in inline mode of a transit network.

FIG. 16 shows example SDN packet handling extensions for ELB in monitoring mode of a transit network.

FIG. 17 shows example SDN packet handling extensions for ELB in inline mode of a transit network.

### DETAILED DESCRIPTION

The embodiments of the present disclosure are applicable to the following four deployment scenarios:

(1) Load balancing function in inline mode in NFV/Cloud data center locations: This involves steering packets between Access network and Virtual Network function elements in cloud data center locations. Specifically, the load balancing function involves steering uplink packets and multiplexing downlink packets from/to access network devices in mobile networks, based on cross correlated information between User and Control Planes from multiple access network protocols (UMTS, CDMA, LTE, WIFI etc.) from/to Virtual Network Function elements in Cloud Data Center locations.

(2) Monitoring Mode Load Balancing in NFV/SDN Locations: This involves load-balancing of monitor mode packets in a Cloud/SDN location. Specifically, this includes distributing control plane and user plane protocol packets from multiple interfaces (S1U, S1AP, S11, IUCS-CP, IUCS-UP, IUPS-CP, IUPS-UP) collected in monitoring mode (for example by using port mirrors or optical taps) to plurality of virtual servers based on server load, and subscriber session anchoring, sector/eNB location information.

(3) Load-Balancing and offloading at operator cloud/datacenter locations or transit network elements: This involves load-balancing and offloading at transit network elements and operator cloud datacenter locations to enterprise clouds based on DNS/Domain/IP address or user identification, IMSI or other parameters: This also includes steering at operator aggregator router locations.

(4) Transit Network—Steering and Load-Balancing to direct the logical interfaces to correct cloud/SDN location: This embodiment includes transporting packets collected from transit network elements in inline or monitoring (either by using cable taps, or port mirrors) from both directions of a logical or physical interface, optionally stripping of headers and/or truncating packets with protocol/stateful knowledge, encapsulating with network headers so as to forward through transit L2/L3 networks in such a way that the packets are load balanced or tunneled to multiple locations, physical/virtual servers that perform real-time packet processing functions.

### Load Balancing Function in Inline Mode in NFV/Cloud Data Center Locations

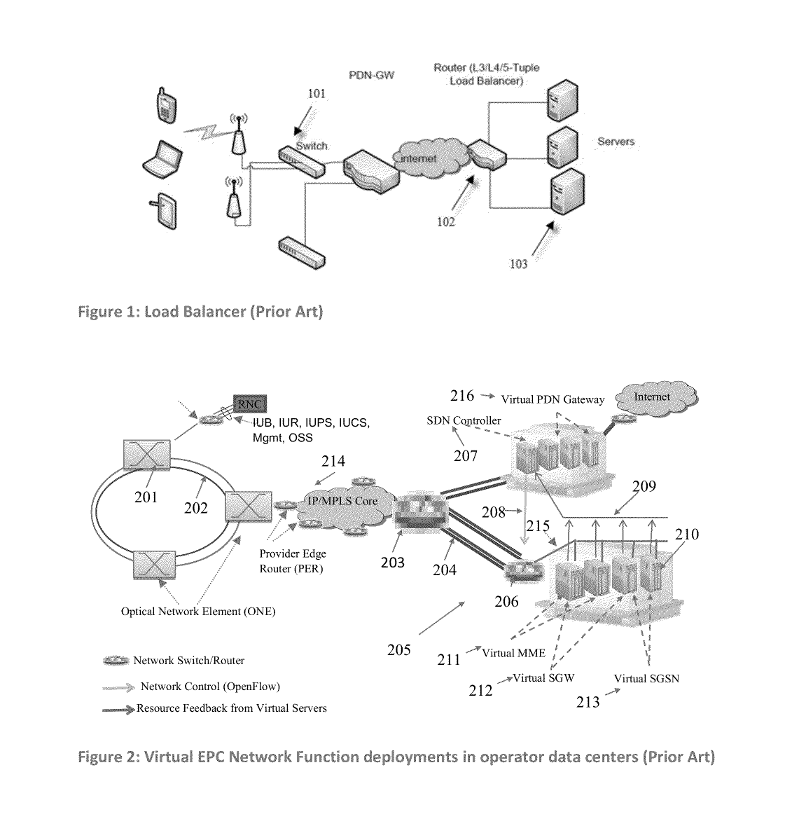

FIG. 1 is a representative prior art load balancer deployed in a data center location distributing load to multiple servers 103. FIG. 1 shows an example deployment of a router or load balancer in the prior art that distributes load to multiple servers at an enterprise location or at Gi location in mobile operator network. The load balancer distributes traffic based on L3/L4/L5 layer headers of user traffic. The PDN Gateway (PDN-GW) 101 in the mobile network terminates user plane tunnels and routes packets through firewall, NAT and other devices, through the internet to the datacenter location. The load-balancer 102 distributes traffic to multiple servers 103, using DNS, and/or IP Packet header fields. Such a load-balancer may be also deployed in operator mobile network, for example to distribute load from a GGSN to multiple Performance Enhancing Proxies (PEPs).

Recently, using new mechanisms such as Software Defined Networks (SDN) and Network Function Virtualization (NFV), mobile operators are migrating standards defined functions, such as MME, SGW, PGW, SGSN, and GGSN, to virtual servers in a Cloud Data Center, and are using SDN methods by which the SDN Controller orchestrates forwarding/routing of data from/to logical protocol interfaces (IUPS-CP, IUPS-UP, S1AP, S1U, S11, S4, S5) to/from virtual servers based on the capabilities and load of virtual servers.

FIG. 2 is an example of a prior art network where mobile network functions such as MME, SGW, PGW, and SGSN, are migrated to virtual servers in a data center using the Software Defined Network paradigm. FIG. 2 is an example of a prior art deployment of Virtualized Network Functions, such as Virtual MME (vMME) 211, Virtual SGW (vSGW) 212, Virtual SGSN (vSGSN) 213, Virtual PDN Gateway (vPGW) 216, Virtual GGSN (vGGSN), in mobile operator SDN/Cloud data center 205. The Core Router or PE Router 203, routes the logical protocols of interest to the Virtual Switch (vSwitch) 206 through the dense interfaces 204. The SDN Controller 207 distributes the traffic (215) backhauled to the datacenter location 205 to the virtual servers by interacting with the vSwitch 206 via OpenFlow protocol 208 per prior art NFV methods. The virtual network functions such as vMME 211, and vSGW 212 are instantiated, based on need, on physical or virtual machines 210 on commodity hardware. The physical and virtual servers 210 report capabilities and usage levels of resources such as CPU, memory, and storage to SDN controller via the interface 209.

The diagram shows that the Control Plane (CP) and User Plane (UP) protocols, such as IUPS, IUCS, S1AP, S1U, are carried through transport network elements, Optical Network Element (ONE) 201, Metro optical Ring 202, IP/MPLS Core 214, Provider Edge Router 203, to the datacenter location 205, and fed to the Virtual Switch (vSwitch) 206. The SDN controller 207 controls the vSwitch 206 using OpenFlow 208 protocol to select and steer traffic to the Virtual Network Functions (VNFs such as vMME 211, vSGW 212, and vSGSN 213). The VNFs are software modules running on physical processing blades or virtual machines in physical hardware 210. The physical/virtual machine capabilities, resource loads and other metrics, is fed back to the SDN Controller 207 which dynamically controls instantiating additional virtual servers when needed, load balancing a specific virtual function such as vSGW to multiple virtual servers and controlling the vSwitch 206 so that corresponding traffic is routed to the right virtual server. For example, vSGW 212 operates on the S1U user plane traffic and needs S11 from vMME 211. The prior art load balancing methods use the server load, and IP ACL rules in the corresponding protocols such as S1U and S11.

Commonly owned U.S. Pat. No. 8,111,630, which is incorporated by reference in its entirety, discloses content caching in the RAN that uses cross correlation between multiple RAN protocols to determine load in sectors, user flows to a sector and performing, Content Caching, Split TCP, and other optimization functions. Commonly owned US Patent Publication 2013/0021933, which is incorporated by reference in its entirety, teaches cross-correlating multiple protocols when estimating Real Time Key Performance Indicators (KPIs), such as Sector Utilization Level (SUL), Subscriber Mobility Index (SMI), and Subscriber Quality Index (SQI), and exporting this information to another device, such as to PCRF, PEP, CDN, or a Load Balancer, to initiate Control and Optimization actions. Such KPI estimation requires the corresponding logical interfaces, for example, S1AP, S1U, S11 for a set of users in the same Sector or eNB, or a number of eNBs in a Venue. If such protocols for a subset of users are forwarded to the same physical Cloud Data Center/SDN Location, and to the set of virtual servers in close proximity, it minimizes processing and communication latencies for Real Time Actions. Additionally, in a virtualization environment, the RAF functions, and the standard VNF functions such as vMME 211, and vSGW 212, run on virtual servers. Thus, traffic orchestration and load balancing function with enhancements to steer logical interfaces (such as S1AP, S1U, and S11) with additional constraints derived from multiprotocol correlation directs related flows to the same virtual server or chassis, thus facilitating close interaction. The current disclosure identifies additional constraints for such a RAN-Aware (Sector, Base Station, Venue, RAT), Subscriber-Aware (User Device type, IMSI), and content aware (Content Type, APN, service type) load balancer. The RAF function running on a virtual server is termed as vRAF; when a single server can't perform RAF function for large number of users, load-balancer distributes the traffic to multiple vRAF's.

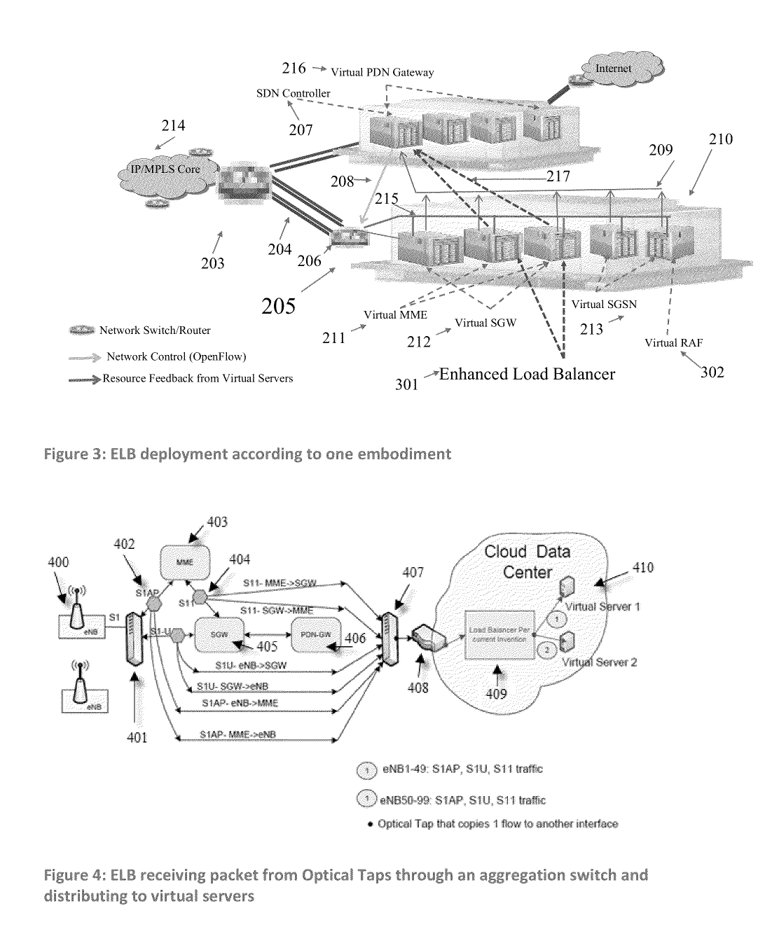

FIG. 3 shows an example deployment configuration where the methods disclosed herein may be deployed. Specifically, FIG. 3 is a first embodiment of an example deployment of Enhanced Load balancer (ELB) 301 where the ELB 301 is shown as a distributed software module running on virtual or physical servers 210. The ELB 301 interacts (217) with the SDN controller 207 orchestrating the forwarding of interface protocol traffic such as IUPS, S1AP, S1U, and S11, which it receives from the virtual switch 206 in the operator SDN data center 205. The Enhanced Load Balancer (ELB) 301 is a software module that incorporates the newly disclosed methods. It may be instantiated on one or more virtual or physical servers in a cloud data center 205. Thus, when a processing unit, such as one disposed in a physical server 210 executes this software module, it is adapted to perform the functions described herein. The remaining elements perform similar functions as in FIG. 2. The ELB 301 interacts with the SDN controller 207 for controlling the vSwitch 206 for directing flows it receives. The ELB 301 also distributes traffic that it receives to the virtual servers via the vSwitch 206, or a different vSwitch depending on the deployment. As previously stated, the ELB 301 allow RAN Aware (sector, eNB, group of eNBs in a location, APN, QCI etc.), Subscriber (user device type, IMSI, etc.), and Content Aware load distribution to multiple virtual or physical functions. This requires analyzing Control Protocols (such as S1AP, S11, and S4) and User Protocols (S1U). The user IP packets in S1U are encapsulated in GTP-U tunnels within transport-ip, for example as:

eNB-IP/SGW-IP/Src-UDP/Dst-UDP/GTPU-SGW-TEID/UE-IP/IP-Dst/Src-TCP/Dst-TCP

Additionally due to IP fragmentation, a larger IP packet is fragmented as:

PKT1: Identification/Flags=MF=1/Frgment-Offset=0/eNB-IP/SGW-IP/Src-UDP/Dst-UDP/GTP-U-SGW-TEID/UE-IP/IP-Dst/Src-TCP/Dst-TCP; and

PKT2: Identification/Flags=MF=0/Fragement-Offset=a/eNB-IP/SGW-IP/remaining packet.

In the above description, only relevant fields of the second packet are shown to demonstrate that the second packet of a fragment does not contain the GTP-U tunnel IDs of user flows. Thus, a load balancer that forwards specific user's GTPU tunnel packets has to perform IP re-assembly before load-balancing. Similarly GTP-Tunnel IDs are dynamically allocated by eNB and SGW. Therefore, a load balancer for forwarding tunnels of the same user needs to determine subscriber identification from control plane and user plane using Destination learning for tunnel aware load balancing. Commonly owned U.S. Pat. No. 8,565,076, which is incorporated by reference in its entirety, defines mechanism to determine subscriber identity. Current L2/L3 switches and Routers do not perform such tunnel aware load balancing. Similarly, the vSwitch forwarding plane and the OpenFlow protocol does not define methods for such tunnel aware load-balancing. The present disclosure proposes performing the tunnel-aware load-balancing in a virtual server which distributes load to virtual functions in a variety of deployments.

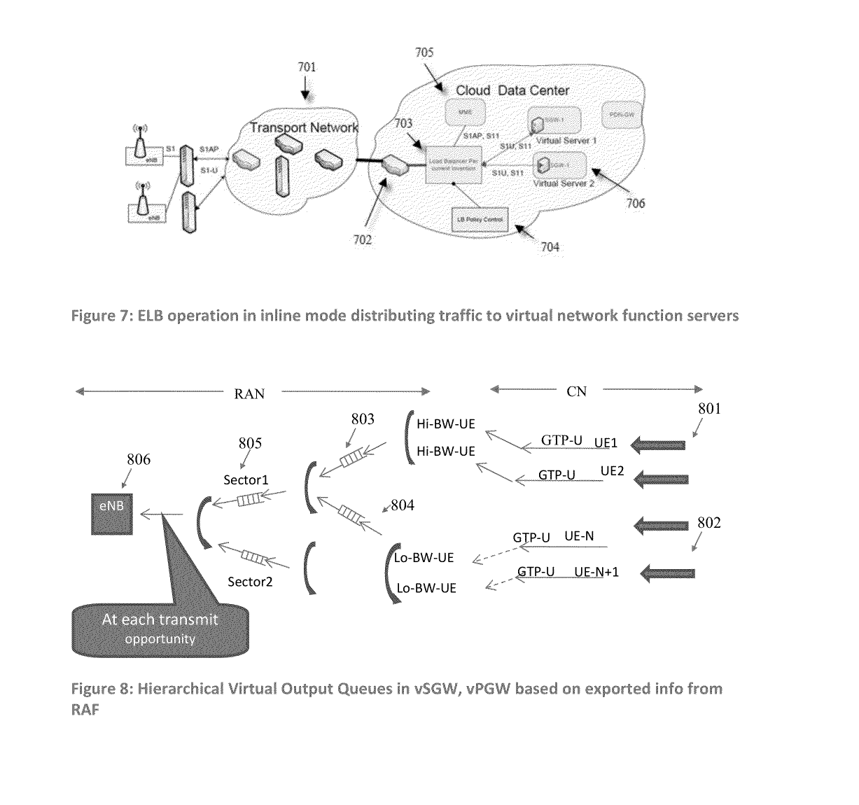

FIG. 7 shows an exemplary ELB 703 deployment in inline mode where it receives interface traffic from mobile protocol interfaces such as S1AP, S1U, IUPS, S11 from transport network 701 via switch/router 702 in the data center location 705, and performs session aware interface protocol distribution to virtual network function servers 706. In this example, ELB 703 is an active network element that receives LB policy from LB Policy control 704. The ELB 703 also participates in L2/L3 configuration and forwarding functions between the other standard network functions.

Additionally, the present disclosure proposes methods for extending the vSwitch forwarding plane, and the OpenFlow methods for tunnel aware load balancing.

As described above, the enhanced load balancer receives traffic of interest, for example, S1U, S1AP, S11 traffic for several thousands of eNBs, and distributing flows based on the LB Policy control and the constraints in the present disclosure. The detailed operations of ELB for inline traffic, where it is distributing traffic to Virtual Network Functions (vMME, vSGW etc.), are as follows:

(1) The load balancer receives incoming traffic from one or more ports of one or more virtual switches (vSwitches). For interface redundancy, it may receive traffic via multiple links that are configured as active/active (both links carrying traffic for some number of eNBs), active/standby where one link is an active link and the second link becomes active in case of failure. In both cases, ELB considers the 2 links pairs as a group.

(2) Distributing S1AP to MME traffic to multiple vMMEs: The constraints include distributing traffic from a group of eNBs that corresponds to geographical area or venue, or in the scope of mobility, to the same vMME. S1AP traffic from one eNB is identified from the eNB's transport IP address or ECGID from the S1AP protocol. The ELB learns the neighborhood map of the eNB either from imported configuration information, or from destination learning, as disclosed in commonly owned U.S. Pat. No. 8,565,076, and selects the target vMME in co-ordination with SDN Controller, since the SDN controller manages the resource utilization levels of the virtual servers. Once the target vMME for the first uplink packet from a new eNB is identified, the downlink packets originate from the same vMME.

(3) When a user initiates a data session, the vMME initiates S11 traffic. The ELB determines the target vSGW based on eNB, neighborhood map, APN, and service type (QCI). The intent of the additional constraints is to target all traffic of users in the same eNB, eNBs in the same venue, etc., so that traffic control policies based on cross correlated KPIs require minimal interaction between multiple virtual servers. In other words, users in the same geographic proximity are grouped together in one embodiment. The selected vSGW initiates S1U traffic, for the specific user; thus it goes through the same virtual server.

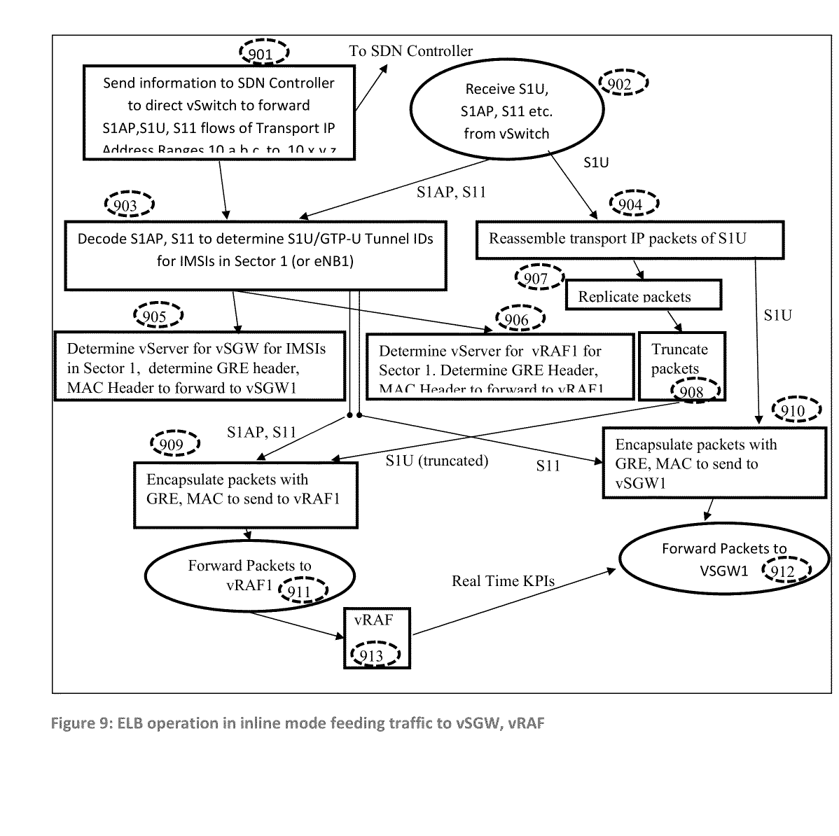

(4) As already outlined, the RAF cross-correlates information from multiple protocols (for example S1U, S1AP, and S11) that are related, for example for same user, the same eNB, a group of ENBs in same venue, same MME, or same APN. In the virtualized environment shown in FIG. 3, the RAF runs as a software module on a virtual server (vRAF) 302 and it needs to receive the corresponding interface protocols for a subset of UEs, eNBs etc., that it could handle. The ELB achieves this by mirroring copies of packets that are sent to the vMME, vSGW, and stripping headers or truncating them before forwarding to a vRAF 302. Since the user plane packet load per vSGW 212 is high, if the virtual servers such as vRAF 302, vSGW 212 that process high packet loads are located on virtual servers in close proximity (same chassis, or 2 servers connected by same vSwitch etc.), it reduces the transit network latencies and transit network load. Thus the ability to distribute the load to virtual servers that process the same subset of related data that are resident in co-located virtual servers is the additional constraint that the present disclosure identifies for instantiating virtual servers and communicating to the SDN controller. FIG. 9 illustrates the functional operation of ELB in this embodiment. ELB interacts with an SDN controller in the datacenter (901) to receive flows of interest such as IUPS-CP, IUPS-UP, S1U, S1AP, and S11. Since the SDN Controller and Virtual Switch are unaware of subscriber sessions or User GTP-U tunnels, the ELB receives a large volume of traffic (902), for each such logical interface, well beyond the capabilities of a single virtual server performing virtual functions such as vSGW, vPGW, and vRAF. The ELB decodes the control protocols (903), such as S1AP, S11 to identify user plane traffic (S1U). User plane S1U packets are re-assembled (904) if they are fragmented at the transport IP level, replicated (907), and then forwarded to VNFs such as vSGW, and to vRAF. The UP packets that are forwarded to vRAF are truncated (908), since vRAF only needs header portions of packets for RT-KPI estimation. The size of truncation is specified by LB policy control. It determines the target virtual servers for vSGW and vRAF by interacting with SDN controller (905, 906). The packets targeted to vRAF are encapsulated with corresponding GRE and MAC headers (909) and forwarded (911) to VRAF 913. Similarly the packets targeted to vSGW are added with corresponding headers (910), and forwarded to vSGW (912). The vRAF 913 forwards Real-Time KPIs and other learned information to virtual servers (912).

(5) Commonly owned US Patent Publication 2013/0021933 discloses computing and exporting several KPIs, such as SUL (Sector Utilization Level), SMI (subscriber Mobility Index etc.) to PCRF, PCEF, PEPs and other devices, that deliver user payload packets to RAN. The SGW (vSGW) delivers S1U/GTP-U user payload packets to a set of eNBs. When such KPIs and user to sector mapping is exported from vRAF to vSGW, it facilitates the vSGW to construct hierarchical virtual output queues as shown in FIG. 8. FIG. 8 is an example of possible actions in a NFV server, such as vSGW, vPGW, and vSGSN, made possible due to receipt of all the related flows (for example, all flows of a UE for multiple services, or flows of all UEs in a sector or venue), and Real-Time KPIs from RAF. The figure shows logical queue 803 for two high bandwidth UEs 801, and a different logical queue 804 for low bandwidth UEs 802. The traffic from the two logical queues 803,804 feeds to sector queue 805 and then to eNB 806. While such scheduling is internal to network elements in RAN, such as eNB, that are aware of sectors, the figure shows core network (CN) elements such as vSGW, vPGW etc., modeling RAN view and maintaining VOQs (virtual output queues). The traffic management in CN controls traffic given to RAN. The vRAF function that estimates Real-Time KPIs exports key metrics such as SUL, SMI etc., to CN VNFs for load based traffic control. This example is intended show possible uses of session-aware load distribution to VNFs, or PEPs in the operator data center. In other words, the figure shows a set of GTP-U tunnels are classified as high-bw UE flows, and others as low-bw UEs, that feed to a single Sector Queue 805, with multiple Sector Queues feeding to a eNB queue, and several eNB queues feeding to a venue queue. It is important to note that the queues are logical in the sense that which user's traffic is prioritized when a transit virtual network device, such as vSGW, is managing packet delivery. In the prior art, core network devices, such as vSGW and vPGW, that process User Plane packets are unaware of sectors or venues, or RAN and User KPIs. Managing subscriber data flows as hierarchical virtual queues in a transit wireline network device is well-known in wireline networks. However what is novel here is adopting the methods to a mobile network based on learned information from multiple protocols.

Thus, in in-line mode, the ELB is in the datapath of the wireless mobile network. As such, it is able to route packets to the appropriate vNF, which may be a vSGW, vSGSN, vMME, vPGW or a vRAF. Thus, in some embodiments, the ELB is able to distribute load among a plurality of servers performing network functions in a wireless mobile network. This is performed by receiving a plurality of packets at the ELB; determining a characteristic of a user or a user device associated with each of the plurality of packets; and forwarding the packets at one of said plurality of servers based on that characteristic, such that packets associated with users or user devices having the same characteristic are forwarded to the same server.

In certain embodiments, the characteristic is an identity of the user, such that all packets associated with the user are forwarded to the same server. In certain embodiments, the characteristic is a sector identifier, such that all packets associated with users belonging to the same sector are forwarded to the same server. In certain embodiments, the characteristic is a plurality of sectors associated with a venue, such that all packets associated with users in said venue are forwarded to the same server. In certain embodiments, the characteristic is control plane sessions of a user, such that all packets associated with control plane sessions of the user are forwarded to the same server. In certain embodiments, the characteristic is user plane sessions of a user, such that all packets associated with user plane sessions of the user are forwarded to the same server. In certain embodiments, the characteristic is an eNB identifier, such that all packets associated with users belonging to the same eNB are forwarded to the same server. In certain embodiments, the characteristic is a RNC identifier, such that all packets associated with users belonging to the same RNC are forwarded to the same server.

### Monitoring Mode Load Balancing in NFV/SDN Locations

The Real-time RAN Analytics and KPI functions (RAF) identified in Commonly owned US Patent Publications 2013/0021933, 2013/0143542, which are incorporated by reference, and the subscriber quality of metrics, require dense processing of control plane and user plane protocols (such as S1AP, S1U, S11, S4, IuCS-CP, IUPS-UP) from network layers L1-L7. Depending on the volume of traffic (such as number of users, eNBs, MMEs, SGWs), and the location where the RAF is deployed, such protocol traffic may be aggregated onto dense network interfaces (1/10/40 Gbps), and a single server or blade, or chassis may not have enough CPU, Memory, Network and Storage resources to perform the RAF functions for that traffic volume. For example, RAF function configuration may involve generating HTTP T1 files with correlated information that contains each HTTP transaction, decorated with user's IMSI, the corresponding CP cause code for session drops, Sector Utilization Level (SUL) and other information, for exporting to Real-Time Analytics platforms, or exporting SUL scores and specific users that need to be throttled at higher SUL levels. Thus, scaling RAF requires distributing logical protocol streams from dense interfaces to multiple virtual servers that perform RAF functions for a subset of users/sector/eNBs. Since RAF function involves dense cross-correlation of multiple protocols, it is essential that such a load balancing scheme distributes related protocol subsets to the same virtual server to minimize real-time communication between virtual servers. As mobile networks are migrating to virtualization environments using NFV/SDN methodologies, operators require dense processing functions, such as RAF, to be deployed on operator cloud data centers on virtual or physical servers on commodity hardware. The logical protocol interfaces such as S1AP, S1U, S11, S4 from many mobile network elements are aggregated and backhauled to such data centers to support Virtual Network Functions such as vMME, vSGSN, vSGW etc. Thus virtual RAF deployment in monitoring mode involves receiving copies of packets using optical taps, or port mirroring of such aggregate interfaces and steering to the ELB, which distributes the traffic to multiple virtual servers using the methods identified herein.

Load-balancing functions and deployment alternatives using monitoring mode are shown in FIGS. 4-6. FIG. 4 is logical diagram showing the ELB 409 in monitoring mode receiving packets from optical taps 402,404 through aggregation switch/routers 407, 408 in the cloud data center. The transit switch/router 401 receives traffic S1 traffic from eNBs 400, and forwards the S1AP 402 flows to MME 403, and S1U flows to SGW 405. The SGW 405 forwards user flows to PDN-GW 406 per 3GPP/LTE architecture. ELB 409 is distributing all the protocol interfaces required by the Real Time Analytics and KPI generation function (RAF) that is deployed on Virtual Servers 1 and 2 410. The figure shows ELB 409 distributing interface traffic based on multi-protocol session awareness. In monitoring mode deployment, ELB 409 is transparent to the network elements, such as eNB 400, MME 403, and SGW 405, which are terminating the protocols such as S1AP, S1U, S11, and IUPS. Thus, it does not participate in L2/L3 protocols with those network elements, and ELB 409 operation does not affect their normal function. However, in some embodiments, the ELB 409 distributes traffic to RAFs (vRAFs) that estimate KPIs and exports to virtual or physical network elements for Real-Time actions.

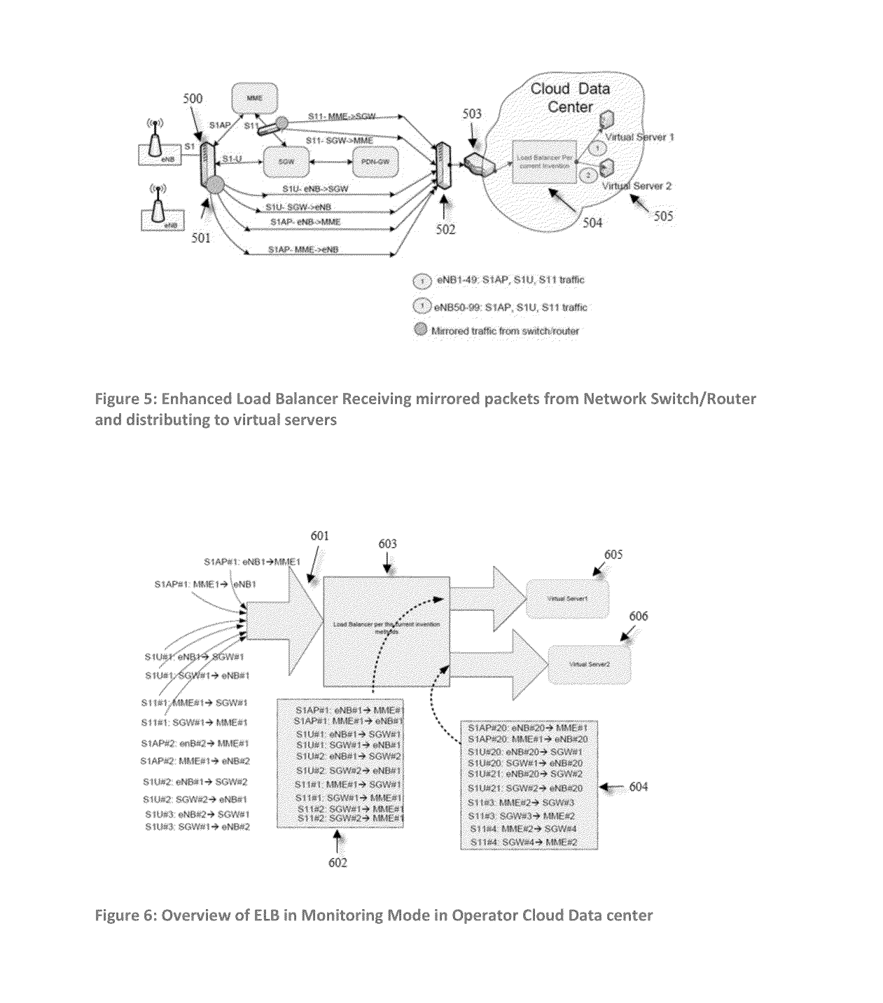

FIG. 5 is a variation of monitoring mode deployment where the ELB 504 in Cloud Data Center 505 is receiving mirrored traffic from other network elements such as Layer 2 Switches or Routers 500, 501, via transit switches 502,503.

FIG. 6 shows flow level operation of ELB 603 when deployed in monitoring mode. ELB 603 is receiving multiple logical flows on an aggregate interface 601. It shows ELB 603 identifying and separating flows 602,604 of each subscriber in all interfaces that are of interest to RAF and distributing subsets to virtual servers 605,606 which are performing RAF function.

Monitoring Mode Load Balancing Involves the following aspects:

1. Control plane flow learning, anchoring, and measuring—Steering control plane flows of a user, and of one or more users within a sector to the same virtual server from multiple interfaces, for example, due to active-active redundancy of the protocol across two physical or logical interfaces (VLANs, or dual homed SCTP sessions), or due to MME load-balancing deployments.

2. Control plane cross correlation to user plane—Steering S1U or IUPS user flows of a user to the same virtual server or a server in close proximity as the virtual server that anchors the user's and sector's control plane flows minimizes Real-time messaging exchanges between virtual servers and associated latencies.

3. User plane load balancing—dense packet processing of user plane flows, such as at DNS, UDP, TCP, HTTP etc. increases resource load on the virtual server. Thus ELB chooses user plane anchoring based on the corresponding load.

4. Defragmentation of user plane transport IP packets—User plane load-balancing requires identifying User Plane GTP-U tunnels and User Equipment (UE) IP addresses. Since transport IP packets may be fragmented and only the first packet of a sequence of packet fragments contains the GTP-U tunnel header as explained earlier, user plane load-balancing requires reassembly of fragmented IP packets. Prior art load balancers that use 5 tuple IP headers are inadequate for user plane load balancing.

5. Bidirectional forwarding of user plane packets—the IP transport network that carries user plane packets uses destination IP forwarding. However, NFV functions, such as SGW, use virtual IP address as transport Address for SGW. In certain redundancy/fail-over scenarios, the two directions of a user flow (eNB to SGW and SGW to eNB) may use different physical interfaces. Thus, the enhanced load balancer (ELB) should forward both directions of user flow to the same virtual server even if the flows are received on 2 different physical interfaces.

6. Scale in/out up/down of virtual servers to adapt system to the offered load on tapped interfaces

7. Control plane rebalancing for growth, de-growth, availability, and other metrics.

8. Overload controls in each type of virtual server Computing real-time analytics based on monitoring of mobile network protocols requires a highly scalable, intelligent system to meet the traffic growth at the deployment location. This system should be able to learn network topology and to automatically scale itself to the offered load by scaling up and/or out virtual server instances. Each virtual server performs one or more key functions to enable the system as a whole to monitor a large network, cross-correlate control and user planes, compute real-time analytics at various levels, such as user and sector, and communicate RAN intelligence to upstream elements for the purposes such as network optimization, network monetization, and user quality of experience optimization.

Packets from tapped interfaces enter the system directly or are tunneled from a remote location as shown in FIGS. 4, 5 and 12. FIG. 12 shows the logical system architecture. Flows 1101 are the tapped traffic coming into the ELB switch fabrics 1102 and 1104. These switch fabrics 1102 and 1104 provide network connectivity between the system components (ELB 1103, Cpvsi 1105, Upvsi 1106, RAvsi 1107) as well as connectivity to external networks. The enhanced load balancers (ELB) 1103 work together to intelligently classify and load balance both control and user plane tapped packets within the system. The control plane virtual server instances (CPvsi) 1105 process all of the control plane data that is exchanged to set up user sessions. CPvsi 1105 learns all of the details such as user id, phone type, user location, APN, user plane tunnel parameters, etc. for each user session. The user plane virtual server instances (UPvsi) 1106 are responsible for processing all of the user plane data. The RAN Analytics virtual server instances (RAvsi) 1107 are responsible for taking data from the CPvsi 1105 and UPvsi 1106 to produce real-time streams of real-time analytic metrics that are exported to upstream network elements.

The ELB identified herein is fully distributed with 1 or more ELB service instances. Packets are forwarded to an ELB virtual server based on configuration and interaction with the SDN Controller in the deployment configuration.

When ELB system is first turned on, it has a minimal set of virtual server instances. Once the tapped interfaces are provisioned and packets start flowing into the system, the ELB system starts to learn the network topology.

Control plane learning is the process of inspecting control plane flows and decoding the associated protocol (i.e. S1AP, GTP-C, RANAP, and others), the interface (i.e. S1-MME, S1-U, S11, A11, IuCS, IuPS, and others), the network elements involved (eNB and MME for S1-MME), and a control plane flow grouping index (i.e. SGSN point code or MME-ID). Control plane learning is described in commonly owned U.S. Pat. Nos. 8,111,630 and 8,208,430, which are incorporated by reference.

In some cases, control plane flows from several interfaces are cross-correlated to learn the identity of a common network element. For example S1-MME and S11 flows are cross-correlated to identify the MME code associated with a given S11 flow. This allows the system to minimize cross correlation traffic between virtual server instances in different locations. For example, in an LTE network, MME and SGW elements are often placed in different geographical locations. The ELB cross correlates S1-MME with S11 for each user session because some parameters, such as sector and IMSI are only available on one of the interfaces. To minimize inter-site cross correlation traffic, the system learns the MME and SGW associated with each user session on both the S1-MME and S11 interfaces. The ELB assigns S11 flow groups based on MME and SGW pairs and it assigns S1-MME flow groups based on MME. The Control Plane virtual server instance (CPvsi) monitoring the S11 interface on a particular MME can subscribe to cross-correlation updates from all of the S1-MME CPvsi's using the learned MME code and SGW pair. That way, the S1-MME CPvsis only need to send each cross-correlation update to a single S11 CPvsi. The MME code is only available on the S1-MME interface. Associating an S11 interface with an MME code is a two-step process. First, the S11 CPvsi subscribes to S1-MME cross-correlation updates from all of the S1-MME CPvsis using SGW only as the subscription key. Once the S11 CPvsi successfully cross correlates S11 and S1-MME for a single user session, it learns the MME code for the S11 flow group. The S11 CPvsi then overwrites its cross-correlation subscription using both SGW and MME code. This will result in each cross correlation update being sent form a single S1-MME CPvsi to a single S11 CPvsi.

In other cases, control plane flows from several interfaces are cross-correlated to be able to assign flows from different interfaces to the same control plane flow group. For example, in UMTS, the SGSN has both RANAP and S4 interfaces and the ELB would like to assign the RANAP and S4 control plane flows associated with the same SGSN point code to the same CPvsi. The SGSN point code is only available in the RANAP interface. Once a flow is classified as S4 and until the ELB is notified of the flow's SGSN-S4-IP relationship to a specific SGSN-RANAP-POINTCODE, it will broadcast the S4 flow to all active RANAP CPvsis. The CPvsi that hosts the RANAP interface that is associated with the same SGSN as the S4 interface will be able to successfully cross-correlate RANAP and S4 user sessions. Once a single user session is cross-correlated, the association of S4 flow to SGSN point code is learned and communicated to the ELB. At this point, the ELB will stop broadcasting the S4 flow to all RANAP CPvsis and instead anchor it to the CPvsi hosting the same SGSN point code. This way, RANAP and S4 can be cross-correlated for each user session optimally without using network resources.

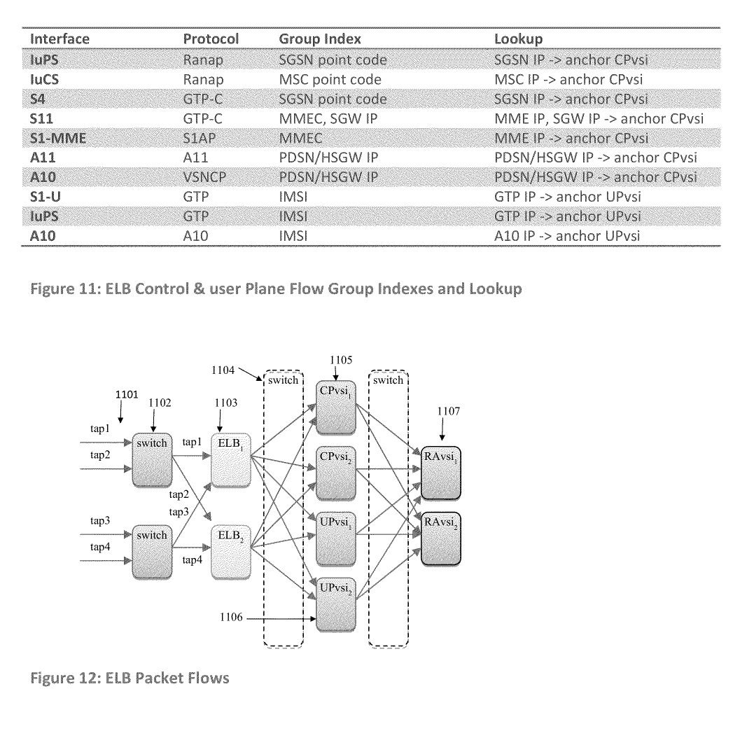

Once a control plane flow grouping index is computed for the flow, the ELB assigns a control plane virtual server instance (CPvsi) to process the control plane flow group. An example is shown in FIG. 11. The ELB takes into consideration current resource utilization and proximity when selecting a CPvsi to anchor the flow group. Once a flow group has been anchored, the ELB creates entries in its forwarding table to map the flow to the anchor. When subsequent packets are received for the same flow group, the ELB forwards them using this flow table entry. The relationship between a control plane flow and its flow group index is stored in nonvolatile memory.

The ELB function identified herein is a software module that runs on one or more virtual servers. The Virtual ELB (vELB) instances work in parallel to learn control plane flows. At any given time, one of the vELBs is designated as the leader of the ELB group. It is the responsibility of the leader vELB to assign an anchor to a new flow group. The ELB paces the learning of control plane flows to avoid overloading any CPvsi. The ELB also triggers the dynamic scale up and out of the CPvsis as needed.

Initially, the workload associated with the processing of a given control plane flow group is unknown. Each CPvsi is responsible for measuring the workload associated with each of its control plane flow groups. The CPvsi computes the daily, weekly, and longer interval busy hour workload for each of its flow groups. These busy hour workloads are stored non-volatilely so that, upon system restart, the ELB can optimally assign flow groups. The busy hour workloads are also used to rebalance the system when required.

The system can be provisioned to monitor a subset of the available protocols, interfaces, and network elements available on the tap. The ELB will discard any unwanted packets from the tapped interfaces. The traffic coming on the tapped interface does not have to be pre-groomed or filtered.

If a vELB service instance becomes unavailable for any reason, the system will assign its workload to a spare vELB service instance and forwards the packets from the associated tapped interface to the new ELB service instance.

If the workload associated with a control plane flow group is larger than the assigned CPvsi can handle, the ELB will first try to rebalance other flow groups from the overloaded CPvsi to another CPvsi. If the workload of a single flow group is larger than a CPvsi can handle, the ELB will trigger a scale up operation for the CPvsi. Finally, after scaling up to the maximum virtual server, if the workload associated with a single flow group remains too large, the ELB will only forward a subset of the flows in the flow group to the associated CPvsi and an alarm will be raised. If a new control plane flow group is learned after all of the CPvsi have been fully loaded, the ELB will trigger a scale out operation to spin up a new CPvsi.

User plane packets arriving at an ELB instance are cross-correlated with the corresponding control plane session to determine session attributes such as IMSI, APN, Sector, etc. The ELB chooses an anchor User Plane virtual server instance (UPvsi) for each user so that all the packets associated with a single user can be processed coherently without the need for inter process communication, as shown in FIG. 11. The ELB chooses an anchor UPvsi based on resource utilization and proximity. Once all the UPvsis are fully loaded, the ELB will trigger a scale out operation to spin up a new UPvsi. Once the maximum number of UPvsis has been reached and all are fully loaded, the ELB will issue an alarm. Once an anchor UPvsi has been chosen for a user plane tunnel, the ELB makes an entry in its forwarding table mapping so that subsequent packets can be forwarded directly to the anchor UPvsi.

Real-time RAN Analytics and KPI estimation function (RAF), as disclosed in commonly owned US Publication 2013/0258865, which is incorporated by reference, requires aggregation at various levels, such as user, sector, APN, and others, and generate Network and User KPIs at each such level. In virtualization environments in NFV/SDN datacenters, RAF runs as a scalable distributed application executing as multiple instances on one or more virtual servers. For each level of aggregation that the system is provisioned to produce, the system will automatically spin up RAN Analytic virtual server instance (RAvsi). For example, if sector level metrics have been provisioned, the system will spin up sector aggregator virtual server instances. Each new sector that is discovered will be assigned to an anchor RAvsi based on resource utilization and proximity. If all RAvsis of a given type become fully loaded, the system will trigger a scale out operation to spin up a new RAvsi. If the maximum number of RAvsi's is reached, the system will not anchor additional sectors and will issue an alarm.

Depending on the provisioned real time metrics (RAF KPIs) provisioned, the system may need to analyze only a portion of each user plane packet. For example, a metric that only depends on TCP level analysis only needs to analyze the packet headers up to the TCP level. In this case, the ELB can optimize the data processing by truncating each user plane packet before forwarding. This can greatly reduce the hardware resources needed by the system.

The ELB always performs packet defragmentation before forwarding packets.

Thus, in monitoring mode, the ELB is not in the datapath of the wireless mobile network. However, it receives all of the packets transmitted in the wireless mobile network and is able to route them to an appropriate vRAF for analysis and exportation of KPIs. Additionally, in some embodiments, the ELB communicates with the SDN controller (see FIG. 3), and therefore is able to influence routing of packets to other vNFs, such as vMME, vSGSN, vSGW, and others.

It should be noted that all of the functions that can be performed in monitoring mode can also be performed in the in-line mode, such as is shown in FIG. 7. This allows RAF KPIs to be computed in in-line mode as well.

Thus, the ELB is able to receive monitored traffic from a tap or mirror port that contains multiple control plane and user plane protocols on an aggregate interface; determine which packets of said monitored traffic belong to a particular user; determine a characteristic of said user or a user device based on the multiple control plane and user plane protocol; distributing all packets having the same determined characteristic to a subset of the plurality of servers. The characteristic may be the identity of the user, a sector identifier, a plurality of sectors associated with a venue, the identity of the eNB, and others. Additionally, the ELB also has the able to modify the packets before forwarding them. In some embodiments, the ELB may reassemble fragmented packets into a single packet to identify all user plane packets associated with a user. In some embodiments, the ELB may truncate packets so as to only include information needed by the server. In some embodiments, the ELB may delete unneeded packets based on control plane protocol analysis and cross correlation of control planes, user planes and user application context.

In certain embodiments, the subset of servers is a group of servers in close physical proximity to one another to minimize inter-site and inter-process cross-correlation traffic and minimize latency. In other embodiments, the subset of servers may be a single server.

### Opportunistic Offload at Intermediate Aggregation Points in Cloud Data Centers

It has been suggested that content caching is beneficial when the cache covers approximately one million users in mobile networks. In many operator networks, user payload traffic is carried within GTP-U tunnels through the RAN and carried through Core Network through RNC, SGSN, SGW, and GGSN/PGW to Gi network. Transport IP addresses and GTP-U tunnels are terminated by GGSN (UMTS) and PGW (LTE), thus facilitating the Caching and Proxy operations in Gi platforms. Core network elements such as SGSN, SGW, GGSN, PGW may carry a lot more users, for example, 5 to 10 million users. Thus, for a cache for one million users, the caching device needs to be deployed in mobile RAN or CN networks below the SGSN, SGW, PGW. For example, the cache may be deployed at transit aggregation router locations, or CN locations, such as SGSN, or SGW, that carry user traffic within GTP-U tunnels. Commonly owned U.S. Pat. No. 8,111,630 identifies methods of caching and performance optimizations in RAN when user payloads are encapsulated in tunnels. Other commonly owned publications, such as U.S. Pat. Nos. 8,451,800, 8,717,890, 8,755,405, and 8,799,480, and US Publications 2011/0167170, and 2013/0021933, all of which are incorporated by reference, outline the benefits of deploying such devices in RAN. As operators migrate to NFV paradigm, deploying CN Network functions such as SGSN, SGW, and MME, in Operator Cloud data Centers, and Content Providers migrate to cloud data centers (such as Amazon Cloud, Google Cloud, and Microsoft cloud), opportunities arise to offload some users, specific types of content or for specific domains, or for specific services. Additional embodiments include using the ELB to steer or offload portions of the user plane traffic carried within user plane tunnels such as S1U, de-encapsulate tunnels and re-construct tunnels in the reverse direction. User plane packets may be extracted by correlating control plane and user plane protocols. The present disclosure identifies issues in offloading portions of user flows to a different cloud provider network and proposes solutions.

(1) Private User IP Address Spaces—Operator network uses private IP addresses that are routable in the operator network only. Offloading to a different cloud network, for example to Google or Amazon cloud, requires network address translation between the two managed private IP domains. TCP/UDP Port NAT, while common, will lose the grouping of TCP connections to a user. Thus, for each new user GTP-U tunnel or new UE-IP identified by the ELB in the S1U (or IUPS) interface, the present disclosure proposes using the ELB to request a dynamic IP address from offload network, and performing IP address NAT between the mobile operator assigned IP address and offload provider IP address. While the DHCP method of requesting IP address, and NAT methods are known in the prior art, what is novel is using such methods for offloading from mobile operator network for mapping to a different provider domain. Alternatively, the ELB could maintain a locally configured private IP address pool in coordination with the offload network (these address should be routable in the offload network) and perform NAT; it could use extension headers to carry UE IMSI or device identification (IMEI), sector location or other information.

(2) While requesting an IP Address for a new tunnel, the ELB adds additional information learned from cross correlation between CP/UP protocols, such as Service Class (QCI), QOS Parameters (MBR, GBR etc.) etc., in the DHCP request. Thus, this mechanism facilitates multiple flows for the same user based on service class, or APN etc., thereby facilitating the offload provider to offer rich set of service classes.

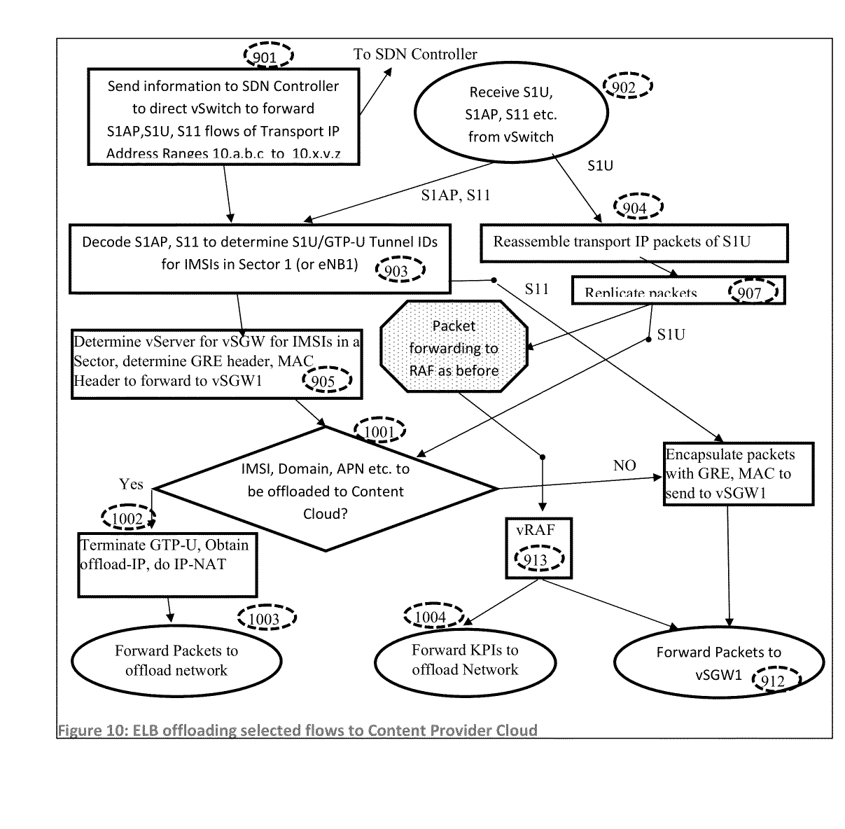

(3) The above offload could be based on group of eNBs within a venue, such as stadium. Thus, while the operator cloud data center and or content provider cloud data center may be at a remote location compared to the venue, offloading venue users only facilitates alternative monetization, content selection, and performance optimization opportunities to the mobile operator. Alternatively, the offload could be for all subscribers of an MVNO Operator based on IMSI, or based on APN, or transport address specified while establishing user plane tunnels. FIG. 10 shows a flow chart according to one embodiment. Like functions are given the same reference designators as appeared in FIG. 9. FIG. 10 shows an additional embodiment of the ELB steering selected user plane traffic based on IMSI, or domain name, APN etc. 1001, to a neighbor content cloud data center. This requires terminating S1U GTP-U tunnels for specific user flows, obtaining a per UE IP address for the specific tunnel from offload network (1002) and forwarding packets to offload network (1003). In addition, learned information (such as sector, set of eNBs, venue information, and RAF estimated KPIs etc) may be forwarded (1004), either using an out-of-band protocol, or via additional headers within user plane protocols.

(4) Alternatively, the ELB may direct user plane flows based on device type (for example, I-phone or Blackberry), or mobile application type, or service plan where such information is learned from control plane or configured through management interfaces or service plane. For example, the ELB may steer I-phone traffic or Netflix application traffic to a different SGW or PEP device, or application server, which facilitates application or device vendor specific routing and service optimizations.

(5) The geographical location where the Network Function or VNF, such as SGW/vSGW, may be in close proximity to Content Provider Cloud Data center such as Google Cloud, or Amazon Cloud, and the latency to such locations may be substantially lower than to the Gi Locations (PGW, Gi Proxy), and through agreements, the mobile service provider and Content Provider Cloud vendor, mobile operator may prefer to offload selected users or selected content or selected services to content provider cloud. Such offload may be specified by domain name in the DNS requests, or identification strings, in the DNS responses, or cloud tags (for example cloud-front tags in http request) indicating they should be offloaded to content provider location. Thus, DNS server address for content cloud is configured, and the ELB forwards such requests to offload device. Content Cloud provider specifies range of IP addresses for the offload device, and supplies those addresses in the DNS Responses resolved through cloud network. Thus, the ELB forwards traffic from those IP addresses.

(6) While offloading selective users or selective flows from mobile network to the offload network, ELB also forwards the learned information such as eNB sector information, user device type, service plan, Content Filtering flag, or Legal Intercept identified for the user from the control plane. It may also forward estimated KPIs, such as SUL, SQI, SMI and others, to the offload network. Such forwarding could be via additional fields in the DNS Requests received from User, or via IP Options, or TCP options. Additionally, ELB may also propagate the leaned information and estimated KPIs to the Origin Servers through the mobile core network via extended fields as above.

(7) For passing learned and estimated KPIs to the origin server, ELB may also use out of band methods instead of additional fields in the active flows. Adding such fields requires specifying user identification, so that origin server could associate out of band information with a specific user. As stated earlier, the Mobile Operator assigns private IP addresses in the mobile network, which will be NATed when such packets traverse the internet to the Content Servers. The present disclosure identifies using session cookies, such as HTTP session cookies, for sending estimated KPIs using out of band methods. Most web servers use session cookies to correlate multiple TCP sessions, and user context. Such a cookie is assigned by the webserver, and specified by clients in subsequent requests. Additionally, many content providers require users to login to the site accounts for enhanced services, and user tracking, search history. While login strings are encrypted, and the cookies are assigned dynamically, since the information and KPIs that ELB exports is in Real-Time, such export could be correlated with specific user sessions majority of times.

### Steering & Load-Balancing at Transit Network Elements to Cloud/Datacenter Locations

Certain embodiments are also applicable to the steering of packets from transit network elements for both inline mode, and monitoring mode deployments in previous sections. The ELB, in cooperation with transit network elements, and using extensions to OpenFlow rules, directs packets to the right Cloud/SDN locations. This steering involves adding standard L2/L3 network headers or GRE or other prior-art tunneling methods. However, the procedures and methods for selecting flows from multiple interfaces to destinations, adding metadata/correlation tags, and unique protocol type for monitor mode packets that constructed from copies of packets from other interfaces and applying multi-level filtering and aggregation rules are key aspects of the present disclosure.

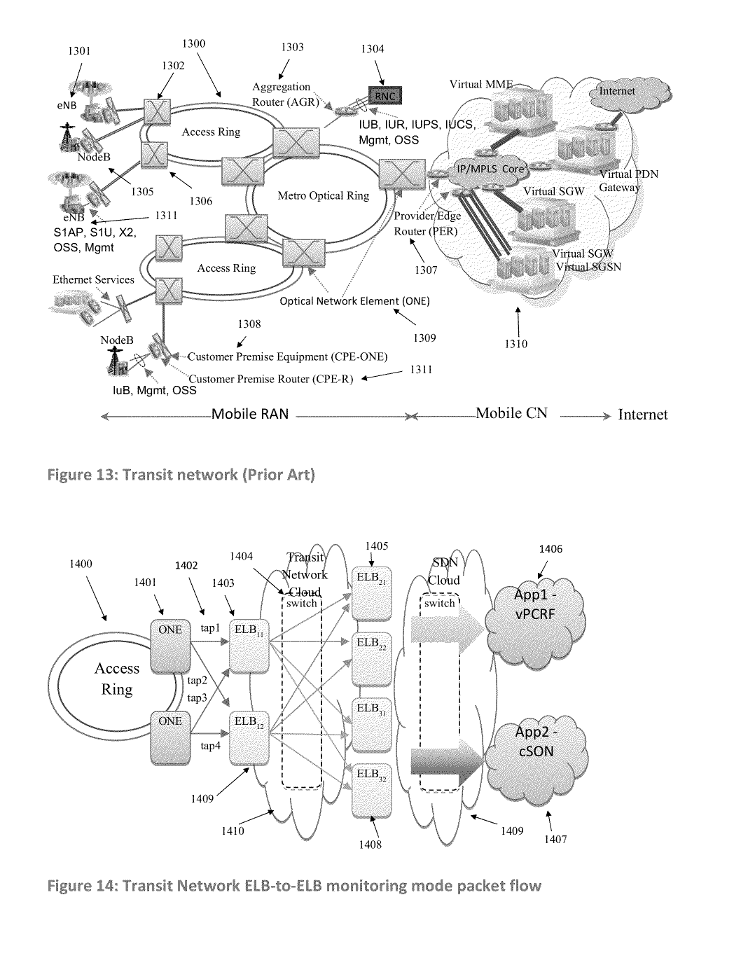

FIG. 13 illustrates example of a WAN network used to support mobile traffic in mobile networks in the prior art. It is divided into Radio Access Network (Mobile RAN), Core Network (Mobile CN), and Internet, relying on underlying transport network elements, such as Optical Network Elements (ONE) 1302, Aggregation Router (AGR) 1303, Access Ring 1300, Metro Optical Ring 1312, Provider Edge Router (PER) 1307. The example UMTS network elements communicate IuB traffic between nodeB 1305 and RNC 1304 over an access network containing multiple ONEs 1302 along the access ring 1300. This is overlayed with one or more transport paths built between AGR 1303, local CPE-ONE 1308 and local CPE-R 1311. IuPS, IuCS, OSS, and Management protocols may communicate from RNC 1304 to network elements in the core 1310, or between RNCs such as IuR. The transport network 1300, 1312 may also transport wireline Ethernet Services or video traffic through the same transport network.

LTE network elements may use the transit network and transport networks in similar manner where eNBs 1301 communicate with core network elements 1310 via core protocols like S1ap, S1u, OSS, and MGMT. This involves several ONEs 1302,1309 and access rings 1300 in the transit network, as well as CPE-R 1311, AGR 1303, and PER 1307 in the transport network. eNBs 1301 may communicate with each other on access ring 1300 via X2 protocol by hair-pinning protocol traffic at AGR 1303.

Most mobile operators build-out a transport network that utilizes an underlying transit network, which they may or may not own. The focus is on implementing services by connecting equipment from the Mobile RAN and core networks. This approach tends to centralize high volume mobile network protocol functions, such as SGSN, GGSN, and MME, to data centers (i.e. core of the network) while limiting the RAN functionality to aggregation points based on L2/L3 forwarding rules that inefficiently utilize the underlying MEF, SONET, or MPLS transit networks.

The high-level goal of SDN network and NFV is to move in a direction of a programmable network to automate the prior art to build a transport path as a service chain with less human intervention. The approach is to manage flows in the network through centralized decision making using SDN controller functions. The building blocks associated with this in prior art include OpenFlow Switch Specification 1.4 that specifies the flow classification and control that are used by a Network Controller.

Another aspect of the current disclosure is to extend the relationship of ELBs in both monitoring mode and inline mode as they relate to transit networks as outlined in FIG. 13. While descriptions and terminology in the current disclosure use 3GPP UMT/LTE networks, these embodiments are applicable to other wireless mobile networks, fixed-wireless networks, wireline networks, or global ISP computing networks.

FIG. 14 illustrates one embodiment operating in monitoring mode in a transit network. In this deployment, there are two levels of ELBs, first-level ELBs 1403, which may reside in the Transit Network Cloud 1410, while the second-level ELBs 1405 reside in the SDN Cloud 1409, closer to SDN controller. ELB 1403 may inspect and anchor traffic flows for different applications, such as vPCRF (virtual Policy Charging and Control Function) 1406 and cSON (centralized Self Organizing Network) 1407. Second-level ELBs 1405,1408 may be responsible for application specific load balancing within the context of vPCRF, or cSON.

The vPCRF 1406 application might require First-level ELB 1403 to extract detailed subscriber-level information such as location, per flow quality of service, HTTP content type, TCP/UDP application information. This would require identifying a set of protocols, such as S1-U, S1ap, IuPS, and IuCS or a subset of the data within the protocols, and anchoring across all of the protocols based on common transport IP address ranges. For example, the ELB 1403 may anchor all S1-U, S1ap traffic associated with a range of SGW IP addresses tied to the same physical device.

In contrast, cSON 1407 application may expect visibility into a different range of protocols such as X2, S1ap, S1-U, and OAM. The protocols may overlap with vPCRF 1406, but the protocol fields may be tailored to cSON algorithms. For example, cSON algorithms are focused on sector and network element constructs.

In both application examples, ELB 1403 is responsible for handling matching multiple protocols, binding them to a secondary load balancer, ELB 1405, or directly to application instances. The present disclosure identifies applications such as PCRF, cSON Server and others, dynamically triggering such multilevel filtering, aggregation, forwarding and load-balancing functions using enhancements to applicable protocols such as OpenFlow.

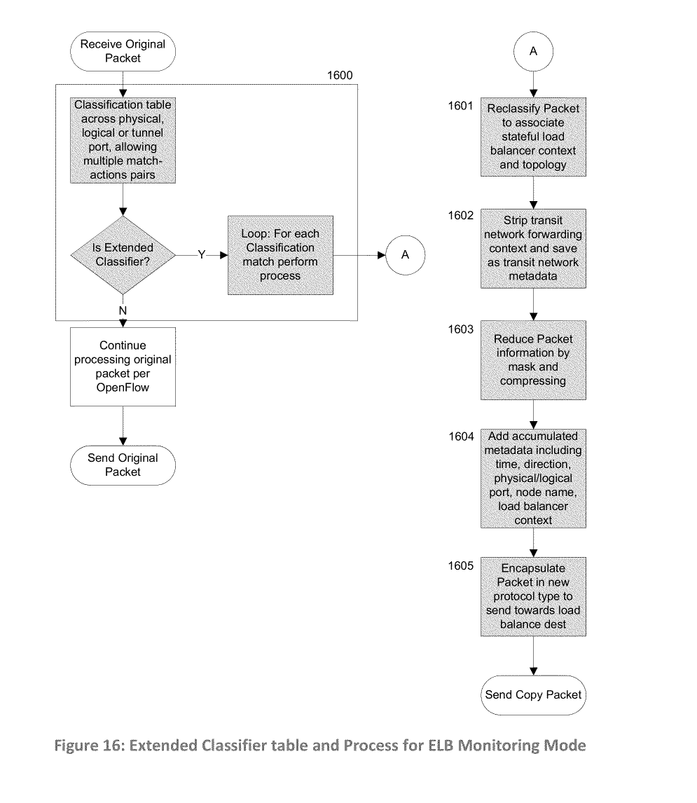

ELB monitoring mode application scenarios require extensions to SDN networking/OpenFlow protocol definition as illustrated in the shaded boxes of FIG. 16. Specifically, the figure illustrates the classification and copying of packets for separate processing (1600), the reclassification to maintain load balancer context and topology (1601), the stripping of transit network protocol details (1602), the reduction and transformation of packets for target application (1603), the addition of load balancing context and meta data to packet (1604), and the encapsulation of the packet in new protocol type for communicating directly or via intermediate ELBs to target application (1605). The following enumerates the limitations with the prior art and solutions identified herein:

(1) Multiple classifications with separate packet copies: Prior art OpenFlow supports packet processing as either unicast or multicast but limits the processing to single action sets on the same packet. The present disclosure supports the ability to match several rules and associated action sets (1600) during the classification phase, based on deeper inspection of packets and associated data, and split the processing into separate copies of the packet to allow for varied action sets. This capability allows mirroring to a number of different applications, for example vPCRF 1406 and cSON 1407.

(2) Topology discovery: Prior art monitoring devices introduce a function of network data deduplication to remove duplicate traffic by comparing packets over a predefined time window for repeats and removing the duplicate packets before the monitoring applications receive it. The present disclosure avoids the need for network data deduplication function by discovering the topology relationship (1601) from different points in network. This is handled by realizing traversal of communication between flows and identifying shortest path. For example, in FIG. 13, this would allow optimized connectivity for X2 or S1 star-topology configuration. For example, eNB 1301 located on access ring 1300 would loop back X2 protocol at an ELB placed at ONE 1302 or 1306 to communicate with eNB 1311 versus at the PER 1307 as is done in prior art. This auto topology discovery and configuration is a necessity with small cells, or wifi hot spots that are meant to be low overhead management.

(3) Flow identification: Prior art taps work on a physical or logical interface basis and copy inbound stream or outbound stream or both streams from that interface to another interface; they do not provide any method to select both directions of flow on an interface, apply flow selection rules on plurality of fields in the packet independent of Layer2/Layer3 semantics defined by Ethernet Bridging, VLAN and IP Forwarding architectures, or add fields to identify directions of streams on that interface. Prior art monitoring platforms rely on either L2/L3 multicast forwarding rules or silicon mirroring functionality, again lacking the understanding of flow semantics. An interface that carries such mirrored packets carries packet flows in one direction only, and if both inbound and outbound packets are aggregated to one interface, that interface will have the MAC Source and Destination Addresses reversed. Additionally, all such flows appear as receive flows on that interface, and certain addresses, such as multicast addresses could appear as source addresses. These packets could not be transported through transit L2/L3 networks. Therefore, prior art methods attempt to overcome this problem by over-riding the corresponding rules by turning off L2 rules. Such packets could not forwarded by a Layer3 router, or portions of such packets, such as Layer3 payloads only, could not be forwarded by encapsulating in GRE tunnels, since the destination MAC addresses do not correspond to the router MAC address expected by an IP router. Thus, the present disclosure identifies stripping unneeded headers and encapsulating them in forwarding headers (MAC in MAC, or GRE or IP-in-IP etc.) using unique protocol type (1605). This facilitates aggregating such multi-level mirrored packets with the unique protocol type from multiple network elements within the transit network and forwarding to dense application servers. The present disclosure identifies the maintaining of metadata (1602) to capture transit network details, such as distinguishing upstream and downstream traffic. This metadata can be communicated during forwarding the packet by explicitly sending metadata information such as direction, time, etc. or by incorporating the information into standard fields with understood semantics, such as encoding odd/even VLAN tag values to represent upstream/downstream traffic. Additional information such as identity of the network element (node name) where the tapping/mirroring are performed, the physical port number of the interface, location (address) of the network element, and a context-id are added using extension headers to portions of packets. The context id facilitates communicating any additional information via out-of-band methods.

(4) Traffic monitoring reduction: Prior art physical and intelligent taps are configured to extract entire physical ports, logical ports/VLANs, IP flows for monitoring purposes. For improving scaling, and reducing transit network bandwidth resources for such traffic, probes or network monitoring devices in the prior art use packet sampling, to copy and transport portions of packets, using a random sampling interval. The data from such sampling methods does not facilitate cross-correlation between multiple protocols, stateful analysis, and generation of Real-Time KPIs, or exporting to analytics platforms. The present disclosure identifies filtering and reduction of traffic (1603) by protocol awareness or substitution with metadata (e.g. all SMTP, IMAP, etc., application ports are categorized as “email”). Meta data may also consist of context information or identifiers marked across different protocols/flows (e.g. all protocol flows associated with a subscriber or all protocol flows associated with a location), which would allow the receiving application to easily cross-correlate the mirrored flows in an application specific way. For example, if both S1AP and S1U traffic for a set of eNBs are required, the ELB may provide metadata information to logically group control plane and user plane protocols with the same values.

(5) Transforming monitoring traffic: Prior art L2/L3 devices allow for creating mirror ports, and may allow for mirroring networks on either end. The present disclosure introduces L2/L3 extensions to allow mirroring of traffic while maintaining semantics of L2/L3 forwarding rules by extending the packet processing functions in SDN network interfaces. For example, transformation of an L2 packet may require the conversion of the destination MAC address to the router MAC so that the filtering and forwarding rules may utilize those in L3 access control lists. This would not be accessible if the L2 packets were forwarded using destination MAC addresses, since prior art devices do not generally transform traffic.

(6) Steering: Prior art tap infrastructure extracts data and performs reduction/aggregation but does not handle failure cases in the monitoring equipment infrastructure, or application level steering cases. The present disclosure performs flow-based load balancing 1601 within either the first or second-level ELB in the following forms:
a. Hierarchical: Hierarchical load balancing for transit network tapping allows separation of application load balancing at appropriate points in the network, where first-level ELB 1403 (see FIG. 14) may consider only load balancing between applications such as vPCRF 1406 and cSON 1407, while second-level ELB 1405 and ELB 1408 would perform intra-application load balancing. The hierarchical ELB allows maintaining layering in the network, separate at the application level and supporting monitoring network redundancy through a mesh of first-level and second-level ELBs. For example, ELB 1403 and ELB 1409 may split the load, but ELB 1409 may take over all traffic if it is realized that ELB 1403 is no longer functioning.
b. Intra-application: Intra-application load balancing can be done by standard hashing techniques, such as incorporating a pool of addresses and masking bits for hashing traffic, or stateful load balancing feedback between ELBs such as 1403, 1405, 1408. The rules functions would be similar to those shown in FIG. 11, but the lookup would redirect to ELBs in a hierarchy.
c. Inter-application: inter-application load balancing may require that the same packet to be classified by two separate applications 1600 using different parts of data. Each application would use a different set of application load balancing fields through steps 1601, 1602, 1603, and 1604.

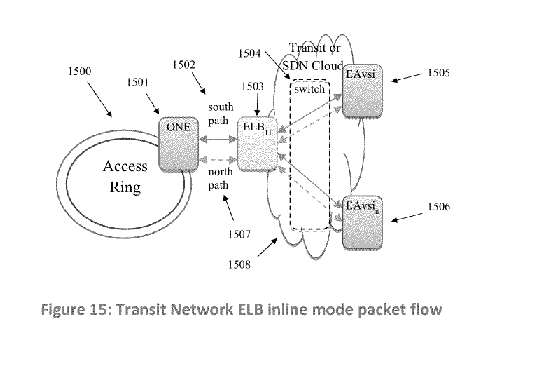

FIG. 15 illustrates deployment of an embodiment of the ELB in inline mode close to a transit network element such as ONE 1501. While the figure shows ELB 1503 as a separate device, it could be a blade in the ONE 1501 that receives traffic from other blades or backplane in the ONE 1501. For example, the switching function 1504 could be switching function within ONE 1501. The application functions shown such as EAvsi1 1505, EAvsi2 1506 are one or more similar or dis-similar application functions that run on physical or virtual servers either within the SDN cloud, Transit cloud 1508 as illustrated or within ONE 1501. In this deployment, ELB 1503 is aware of the paths in the underlying transport from ONE 1501. This allows the ELB 1503 to perform load balancing function to distribute traffic to one or more application servers close to the transit network device and export the results or KPIs or selected packet flows through the same transit network to the CN locations. The ELB 1503 logically sits as a bump in the wire on the access ring 1500 by accepting east-west transport paths from the ring and mapping them to south path 1502, and north path 1507, respectively. The south path 1502 in FIG. 15 refers to traffic between the ELB 1503 and Access ring 1500 and the north path 1507 refers traffic towards the Core Network 1508. Multiple instances of the same application or different applications are represented as Edge Application virtual server instances (EAvsi) 1505, 1506. For applications that are the same, this can allow mobile edge security checking while traffic resides on the ring 1500, allowing for IDS/IPS functionality to discard packets received from the south path 1502 if a security threat was flagged, or allow packets to proceed onwards to north path 1507, or by providing response to south path 1502, reporting any issues. Alternatively, application may be a number of content data networks or cloud infrastructure equipment that is handling on the edge of the network by understanding the underlying subscriber authentication and mapping to CDN or cloud (e.g. domain mappings).

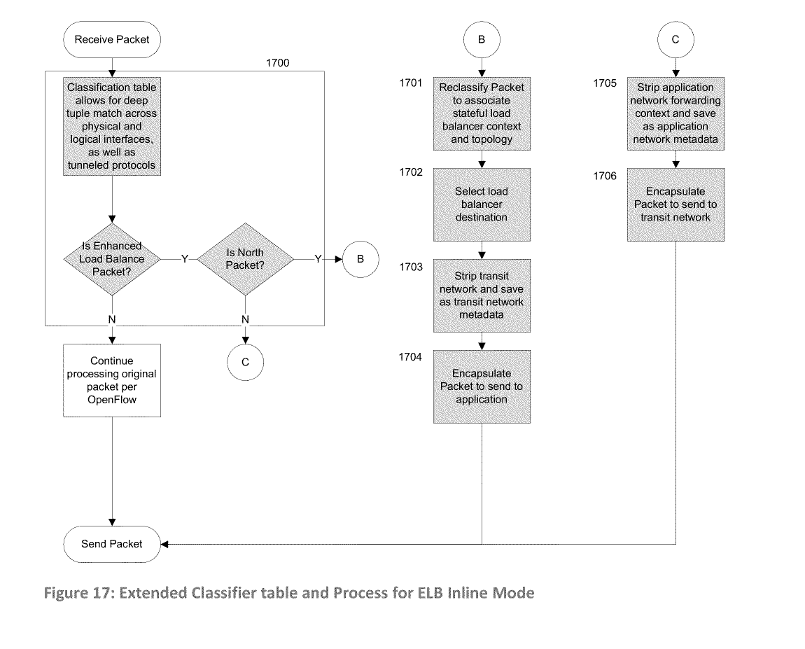

ELB inline mode scenarios require extensions to SDN networking/OpenFlow protocol definitions such as flow classification and direction (1700), reclassification to maintain load balancer context and topology (1701), select load balancer (1702), unpacking traffic and saving state for bidirectional flows (1703, 1705), and encapsulate for required network transmission (1704, 1706) are illustrated in FIG. 17. Some of the packet handling activity overlaps with monitoring mode and is therefore not repeated. The following enumerates limitations with prior art and solutions introduced herein:

(1) Flow classification: Prior art networks handle flow classification based on current packet inspection to handle tuple matching from physical or logical port, L2 headers, and L3 headers. The present disclosure introduces deeper classification 1700 allowing for flows to be classified across diverse paths such as multipath TCP, tunneling protocols, underlying transport technologies (e.g. SONET paths), as well as matching across protocols to introduce a common group flow identifier that anchors flow contexts and meta data across protocols. This allows flow classification and actions to be taken on user plane and control plane data.

(2) Topology discovery: Prior art networks are optimized for either end server applications or internet traffic transport and do not consider optimization of intermediate transit networks. The present disclosure performs topology discovery 1701 to direct best locations to instantiate inline mode ELBs to facilitate introducing dense mobile edge computing functions, such as CDNs, gaming/application servers, hosted application services, M2M services, signaling gateway functions, and directing optimal communication between such devices or cloud computing locations described earlier. For example, realizing that the majority of traffic paths come from a particular access network 1300, ELBs may be instantiated in coordination with SDN controller at a particular ONE location.

(3) Load balancer decision 1702: Prior art load balancer functions implement stateful information to anchor sessions or flows to certain devices, or rely on stateless algorithms (round-robin) where common database on the application server side provides context. The present disclosure uses information gleaned from a plurality of transit network protocols, transport network protocols, and application in coordination with the SDN controller to instantiate a load balancer function and corresponding applications. The ELB may perform optimizations across a number of applications using the transit network such as:
a. Optimized signaling paths: Determine best path for signaling path flows by calculating optimal routes. For example, through inspection of signaling traffic activity in a monitoring mode application, the ELB in coordination with the SDN controller may propose optimal routes based on distance, performance etc. This could result in changing X2 protocol from traversing eNB 1301->PER 1307->eNB 1311 to eNB 1301->ONE 1302->eNB 1311.
b. Optimized data paths: Similar to optimized signaling paths, optimized data paths might connect client to server communication or peer-to-peer communication at ideal location. The present disclosure allows for hair-pinning of local or close proximity traffic. For example, if a client on eNB 1301 was communicating to a server on NodeB 1305, traditional traffic would traverse to the virtual core 1310. In accordance with the embodiment depicted in FIG. 15, an intermediate ELB 1503 placed at a ONE 1501 could integrate with edge computing platform to handle local requests without traversing the network. Similar examples were provided in early section on “Opportunistic Offload at intermediate aggregation points in the cloud data center”.

(4) Bidirectional Load Balancer Context 1703 and 1705: Prior art load balancing is confined to distributing the load of work for better scaling. The present disclosure brings context sensitive constructs and saving of state to ensure load balancer traffic can work in bidirectional case when deployed in dissimilar networks such as is found in transit networks.

Other embodiments of ELB in a transit network include Ethernet services, MPLS tagging networks, GMPLS, ASTN, CPE-R/PER/AGR routers, and mesh and star topologies.

What is claimed is:

1. A method of distributing load among a plurality of servers performing network functions in a wireless mobile network, comprising:
receiving a plurality of packets at a node;
determining a characteristic of a user or a user device associated with each of said plurality of packets; and
forwarding said packets at one of said plurality of servers based on said characteristic, such that packets associated with users or user devices having the same characteristic are forwarded to the same server.

2. The method of claim 1, wherein said characteristic comprises an identity of said user, such that all packets associated with said user are forwarded to said same server.

3. The method of claim 1, wherein said characteristic comprises a sector identifier, such that all packets associated with users belonging to the same sector are forwarded to said same server.

4. The method of claim 1, wherein said characteristic comprises a plurality of sectors associated with a venue, such that all packets associated with user in said venue are forwarded to said same server.

5. The method of claim 1, wherein said characteristic comprises control plane sessions of a user, such that all packets associated with control plane sessions of said user are forwarded to said same server.

6. The method of claim 1, wherein said characteristic comprises user plane sessions of a user, such that all packets associated with user plane sessions of said user are forwarded to said same server.

7. The method of claim 1, wherein said characteristic comprises an eNB identifier, such that all packets associated with users belonging to the same eNB are forwarded to said same server.

8. The method of claim 1, wherein said characteristic comprises an RNC identifier, such that all packets associated with users belonging to the same RNC are forwarded to said same server.

9. A method of distributing load among a plurality of servers performing real-time generation of key performance indicators (KPIs) for a mobile wireless network, comprising:
receiving monitored traffic from a tap or mirror port that contains multiple control plane and user plane protocols on an aggregate interface;
determining which packets of said monitored traffic belong to a particular user;
determining a characteristic of said user or a user device based on said multiple control plane and user plane protocol;
distributing all packets having the same determined characteristic to a subset of said plurality of servers.

10. The method of claim 9, wherein said characteristic comprises an identity of said user, such that all packets associated with said user are forwarded to said subset.

11. The method of claim 9, wherein said characteristic comprises a sector identifier, such that all packets associated with users belonging to the same sector are forwarded to said subset.

12. The method of claim 9, wherein said characteristic comprises an eNB identifier, such that all packets associated with users belonging to the same eNB are forwarded to said subset.

13. The method of claim 9, further comprising modifying said packets before forwarding to a server.

14. The method of claim 13, wherein said modifying comprising reassembling fragmented packets into a single packet to identify all user plane packets associated with a user.

15. The method of claim 13, wherein said modifying comprising truncating packets so as to only include information needed by said server.

16. The method of claim 9, further comprising deleting unneeded packets based on control plane protocol analysis and cross correlation of control planes, user planes and user application context.

17. The method of claim 9, wherein said subset comprises a group of servers in close physical proximity to one another to minimize inter-site and inter-process cross-correlation traffic and minimize latency.

18. The method of claim 9, wherein said subset comprises a single server.

19. The method of claim 9, further comprising determining a topology of said mobile wireless network based on analysis of said packets.

20. The method of claim 9, further comprising sending information to a SDN controller, wherein said SDN controller controls a switch which routes packets to a server performing a network function.
